(19) United States
(12) Patent Application Publication
(10) Pub. No.: US 2007/0229509 A1
(43) Pub. Date: Oct. 4, 2007

(54) Graphic system, broken line texture image generation apparatus, and broken line texture image generation method

(75) Inventor: Hideaki Yamauchi, Kawasaki (JP)

Correspondence Address: ARENT FOX PLLC, 1050 CONNECTICUT AVENUE, N.W., SUITE 400, WASHINGTON, DC, 20036, US

(73) Assignee: Fujitsu Limited

(21) Appl. No.: 11/489,586

(22) Filed: Jul. 20, 2006

(30) Foreign Application Priority Data
Mar. 28, 2006 (JP) 2006-086926

(51) Int. Cl. G09G 5/00; G06T 11/20

(52) U.S. Cl. 345/443; 345/582

(57) ABSTRACT

A graphic system includes a texture storage area 4b for storing a broken line texture image in which broken line patterns by modifier function are arranged, a texture module 3b for reading a specific broken line pattern arranged in the broken line texture image based on coordinates on the broken line texture image, a drawing module 3c for drawing a broken line using the broken line pattern read by the texture module 3b.

### CROSS-REFERENCE TO RELATED APPLICATIONS

This application is based upon and claims the benefit of priority from the prior Japanese Patent Application No. 2006-086926 filed on Mar. 28, 2006, the entire contents of which are incorporated herein by reference.

### BACKGROUND OF THE INVENTION

1. Field of the Invention

The present invention relates to a graphic system for drawing a broken line using a broken line texture image, and an apparatus and a method for generating a broken line texture image.

2. Description of the Related Art

There has conventionally been a graphic system for drawing a broken line having a thick line width by texture mapping of pasting a texture image of a broken line pattern (broken line texture image) on a broken curve graphic (broken curve segment) by utilizing a general-purpose texture mapping mechanism. In this system, a broken line texture image is prepared for each variation in pattern, color, etc. of a broken line pattern. When a broken line texture image is pasted on the broken curve graphic, preparations such as memory addressing for a reference texture image, etc. are made again each time it is pasted.

There is also a graphic system for drawing a broken line in other methods. For example, the patent document 1 (Japanese Published Patent Application No. H10-188006) discloses an apparatus for drawing desired line graphics in a solid line drawing process based on a contour and a background by generating a desired background seen through from inside the contour when the information about the contour expressing a broken line to be drawn by a solid line is input. Also, the patent document 2 (Japanese Published Patent Application No. 2000-108447) discloses an apparatus of inputting line data when a broken line is drawn, dividing a straight line at a predetermined rate and generating a partial straight line by a broken line for the broken line drawing portion, generating a partial straight line portion path area with the partial straight line portion centered corresponding to the number of broken line drawing portions, converting the partial straight line portion path area into bit map data and painting the area in foreground color, generating an entire straight line portion path area with the straight line centered, converting the entire straight line portion path area into bit map data and painting the area in background color, overwriting and combining the bit map data of the partial straight line portion path area and the bit map data of the entire straight line portion path area, and printing the bit map data.

In the above-mentioned graphic system of drawing a broken line by the texture mapping by utilizing the general-purpose texture mapping mechanism, it is necessary to prepare a broken line texture image for each variation of a broken line pattern. Therefore, when there are an enormous number of variations, it is very hard to generate and manage the broken line texture images. Additionally, it is not possible to dynamically generate a desired broken line texture image. Furthermore, when a broken line texture image is pasted on a broken curve graphic, it is necessary to make again the preparations such as memory addressing, etc. of reference texture image s, etc. each time the image is pasted, thereby causing performance degradation by overhead required to switch memory addresses, etc.

### SUMMARY OF THE INVENTION

The present invention has been developed to solve the above-mentioned problems, and aims at providing a graphic system, a broken line texture image generation apparatus, and a broken line texture image generating method for facilitating the generation and management of a broken line texture image and reducing the performance degradation by the overhead required when a broken line texture image is pasted.

To attain the above-mentioned objectives, the graphic system according to the first aspect of the present invention includes: a storage unit for storing a broken line texture image in which a broken line pattern by modifier function is arranged; a read unit for reading a specific broken line pattern arranged in the broken line texture image based on the coordinates on the broken line texture image; and a drawing unit for drawing a broken line using a broken line pattern read by the read unit.

With the above-mentioned configuration, since a broken line pattern by modifier function is arranged in a broken line texture image, it is easy to manage a broken line texture image. In addition, since a broken line pattern by modifier function can be read only by moving the coordinates in the same broken line texture image, the performance degradation by the overhead required when a broken line texture image is pasted can be reduced.

The first aspect can also be constituted by: a generation unit for newly generating a broken line texture image having a first area in which a broken line pattern by modifier function is arranged and a second area used as a work area in which the broken line pattern is generated; a paint unit for painting a first row in the second area in a foreground color of a broken line, and painting a second row in the second area in a background color of the broken line; an assigned color paint unit for painting in assigned color a third row in the second area corresponding to a pattern of the broken line; and a write unit for writing a broken line pattern relating to the broken line to a specific row in the first area based on the first and second rows painted by the paint unit and the third row painted in assigned color by the assigned color paint unit.

In this aspect, a broken line texture image can be more simply and easily generated.

To attain the above-mentioned objective, the broken line texture image generation apparatus according to the second aspect of the present invention includes: a generation unit for newly generating a broken line texture image having a first area in which a broken line pattern by modifier function is arranged and a second area used as a work area in which the broken line pattern is generated; a paint unit for painting a first row in the second area in a foreground color of a broken line, and painting a second row in the second area in a background color of the broken line; an assigned color paint unit for painting in assigned color a third row in the second area corresponding to a pattern of the broken line; and a write unit for writing a broken line pattern relating to the broken line to a specific row in the first area based on the first and second rows painted by the paint unit and the third row painted in assigned color by the assigned color paint unit.

To attain the above-mentioned objective, the broken line texture image generating method according to the third aspect of the present invention includes: generating a broken line texture image having a first area in which a broken line pattern by modifier function is arranged and a second area used as a work area in which the broken line pattern is generated; painting a first row in the second area in a foreground color of a broken line, and painting a second row in the second area in a background color of the broken line; painting in assigned color a third row in the second area corresponding to a pattern of the broken line; and writing a broken line pattern relating to the broken line to a specific row in the first area based on the first and second painted in assigned color and the third row painted in assigned color.

With the above-mentioned broken line texture image generation apparatus and broken line texture image generating method, a broken line texture image can be simply and easily generated.

### BRIEF DESCRIPTION OF THE DRAWINGS

FIG. 1 shows the main configuration of the graphic system according to a mode for embodying the present invention;

FIG. 2 shows an example of a broken line texture image;

FIG. 3 shows an example of drawing a broken line;

FIG. 4A is a first view showing an example of drawing a broken curve graphic by broken lines;

FIG. 4B is a second view showing an example of drawing a broken curve graphic by broken lines;

FIG. 4C is a third view showing an example of drawing a broken curve graphic by broken lines;

FIG. 5A is a first view for explanation of a process of generating a body broken line pattern;

FIG. 5B is a second view for explanation of a process of generating a body broken line pattern;

FIG. 5C is a third view for explanation of a process of generating a body broken line pattern;

FIG. 6A is a first view for explanation of a process of generating a frame broken line pattern;

FIG. 6B is a second view for explanation of a process of generating a frame broken line pattern;

FIG. 6C is a third view for explanation of a process of generating a frame broken line pattern;

FIG. 7A is a first view for explanation of a process of generating a shading broken line pattern;

FIG. 7B is a second view for explanation of a process of generating a shading broken line pattern; and

FIG. 7C is a third view for explanation of a process of generating a shading broken line pattern.

### DESCRIPTION OF THE PREFERRED EMBODIMENT

The mode for embodying the present invention is described below by referring to the attached drawings.

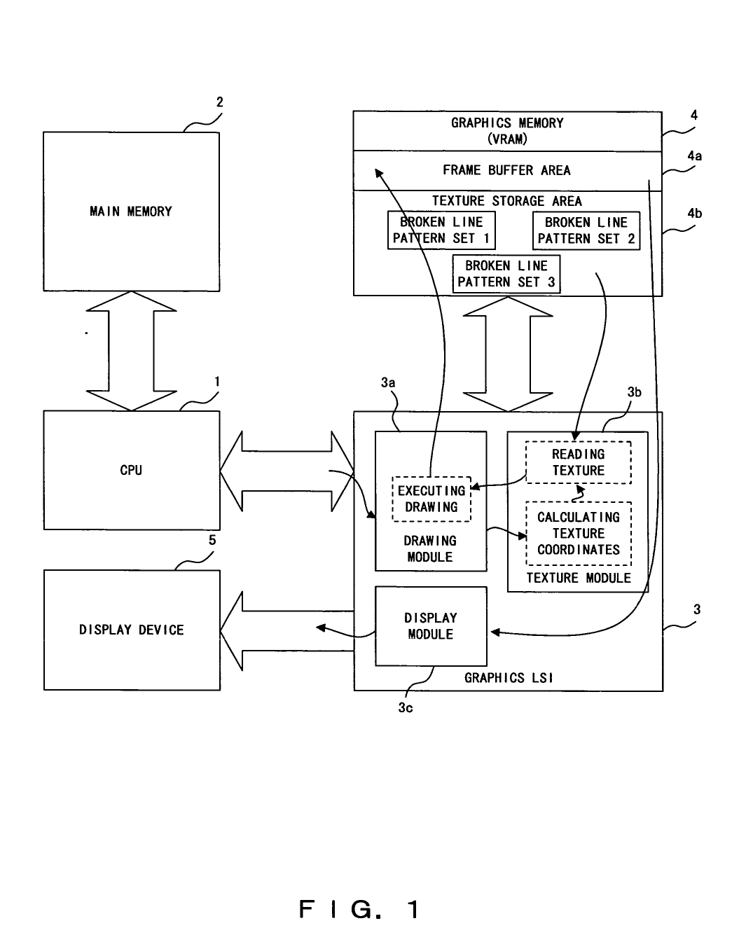

FIG. 1 shows the main configuration of the graphic system according to a mode for embodying the present invention. The graphic system can be a broken line texture image generation apparatus because the system is specifically capable of generating a broken line texture image described later.

As shown in FIG. 1, the graphic system according to the mode for embodying the present invention comprises a CPU 1, main memory 2, a graphics LSI 3, graphics memory (VRAM) 4, and a display device 5.

The CPU 1 controls the entire operation of the graphic system by reading and executing the program stored in the ROM not shown in the attached drawings. The main memory 2 is used as a work area for execution of the control process performed by the CPU 1.

The graphics LSI 3 comprises a drawing module 3a for drawing a broken line, etc. in a frame buffer area 4a of the graphics memory 4, a texture module 3b for reading a texture image from a texture storage area 4b of the graphics memory 4, and a display module 3c for a read and display of the contents drawn in the frame buffer area 4a of the graphics memory 4 on the display device 5, and performs the process under the control of the CPU 1. The modules 3a, 3b, and 3c can be realized by hardware, software, or both of them.

The graphics memory 4 comprises the frame buffer area 4a in which a drawing process is performed, and the texture storage area 4b storing a texture image such as a broken line texture image, etc., and is used in the process performed by the graphics LSI 3. FIG. 1 shows the storage of three broken line texture images (“broken line pattern set 1”, “broken line pattern set 2”, and “broken line pattern set 3”) in the texture storage area 4b. Each of the broken line texture images is independently provided for each set of broken line patterns by modifier function applied to the same segment. These broken line texture images are loaded from the storage device not shown in the attached drawings when the graphic system is activated, or generated in the generating process described later.

The display device 5 displays the contents drawn in the frame buffer area 4a of the graphics memory 4.

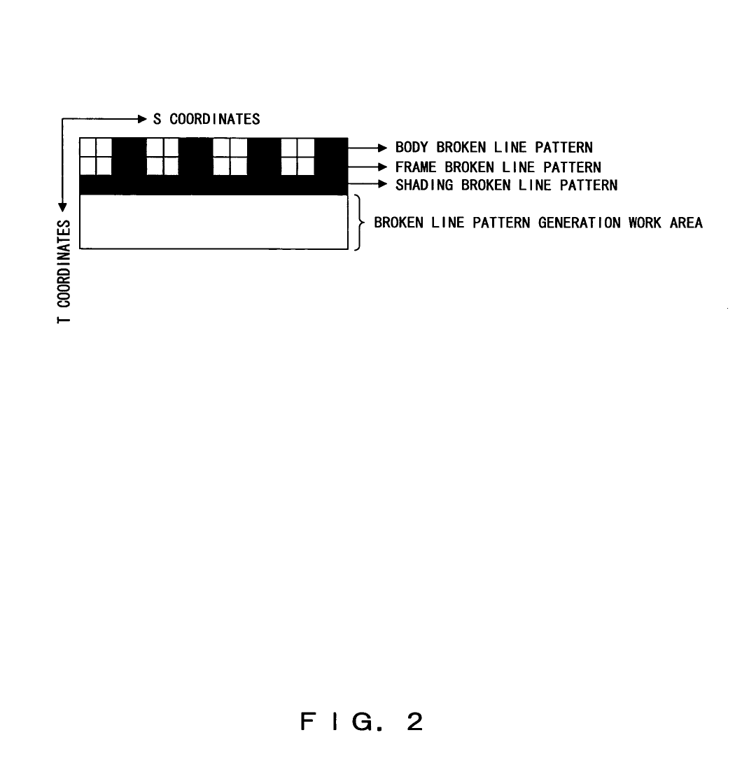

FIG. 2 shows an example of a broken line texture image.

As shown in FIG. 2, the broken line pattern of a broken line texture image is defined in the horizontal direction (S coordinates), and the broken line pattern by modifier function applied to the same segment is arranged in the vertical direction (T coordinates). In the example shown in FIG. 2, as a broken line pattern by modifier function, a body broken line pattern is arranged in the first row, a broken line pattern for a frame (hereinafter referred to simply as a “frame broken line pattern”) is arranged in the second row, and a broken line pattern for shading (hereinafter referred to simply as a “shading broken line pattern”) is arranged in the third row.

In the broken line texture image, the broken line patterns bymodifier function are arranged in the upper area (first area), and an area as a broken line pattern generation work area is reserved in the lower area (second area) . This area is described later in detail, and is used when abroken line pattern arranged in the upper portion is generated.

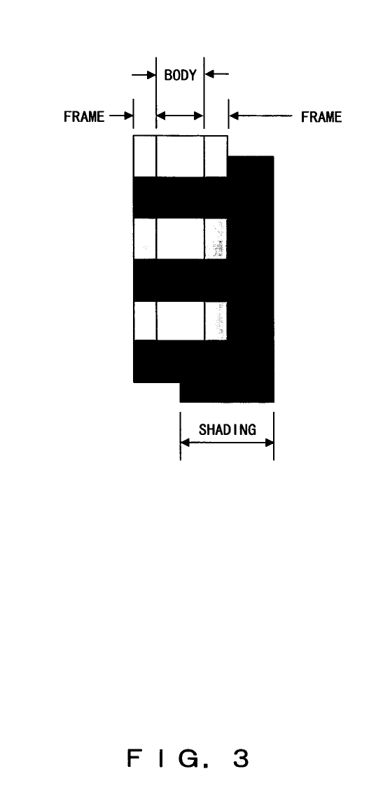

Described next is the broken line drawing process performed by the graphics LSI 3 as a process performed in the graphic system. In this example, the broken line texture image shown in FIG. 2 is stored in the texture storage area 4b, and the broken line shown in FIG. 3 is drawn using the body, frame, and shading broken line patterns included in the broken line texture image.

First, the CPU 1 issues an instruction to draw a broken line to the graphics LSI 3. Upon receipt of the instruction, the drawing module 3a instruct the texture module 3b to request a necessary broken line pattern for drawing.

Upon receipt of the request instruction, the texture module 3b calculates the T coordinates for a read of a necessary broken line pattern from the broken line texture image shown in FIG. 2 stored in the texture storage area 4b, reads the necessary body, frame, and shading broken line patterns based on the T coordinates, and passes them to the drawing module 3a. The calculated T coordinates correspond to each of the first to third rows in the broken line texture image shown in FIG. 2.

The drawing module 3a draws a segment in the frame buffer area 4a, pastes the body, frame, and shading broken line patterns received from the texture module 3b on the segment, and draws the broken line shown in FIG. 3.

The display module 3c reads the contents drawn in the frame buffer area 4a, and displays them on the display device 5.

In the above-mentioned drawing process, the broken line shown in FIG. 3 is drawn in the frame buffer area 4a, and is displayed on the display device 5.

Thus, in the drawing process, it is not necessary as in the conventional technology to reset the drawing attributes or newly specify the memory address of a reference texture image each time a body, frame, or shading broken line is drawn. That is, only by changing the T coordinates of the broken line texture image shown in FIG. 2, a broken line can be drawn, thereby reducing the performance degradation by the overhead.

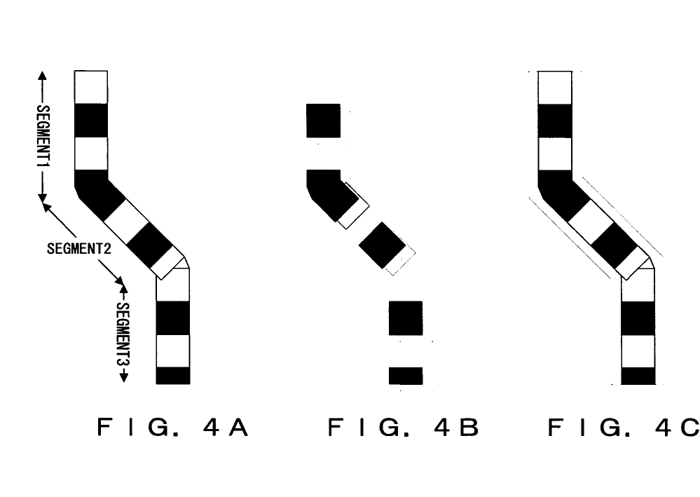

In this example, the broken line shown in FIG. 3 is drawn using the broken line texture image shown in FIG. 2. Similarly, it is possible to draw a broken curve graphic using the broken line shown in FIGS. 4A, 4B, and 4C using the broken line texture image stored in the texture storage area 4b. FIG. 4A shows an example of drawing a broken curve graphic by body broken lines. Each of the “segment 1”, the “segment 2”, and the “segment 3” shown in FIG. 4A shows a segment between the bending points of the broken curve graphic. FIG. 4B shows an example of drawing a broken curve graphic by the broken lines modified by the shading broken lines for body broken lines . FIG. 4C shows an example of drawing a broken curve graphic by the broken lines modified by the frame broken lines as solid line framing for the body broken lines. In FIG. 4C, it is obvious that framing with broken lines can replace framing with solid lines using the modification with frame broken lines.

Next, as the process performed in the graphic system, the process of generating a broken line texture image by the graphics LSI 3 is explained below. An example of generating broken line texture image shown in FIG. 2 is described below.

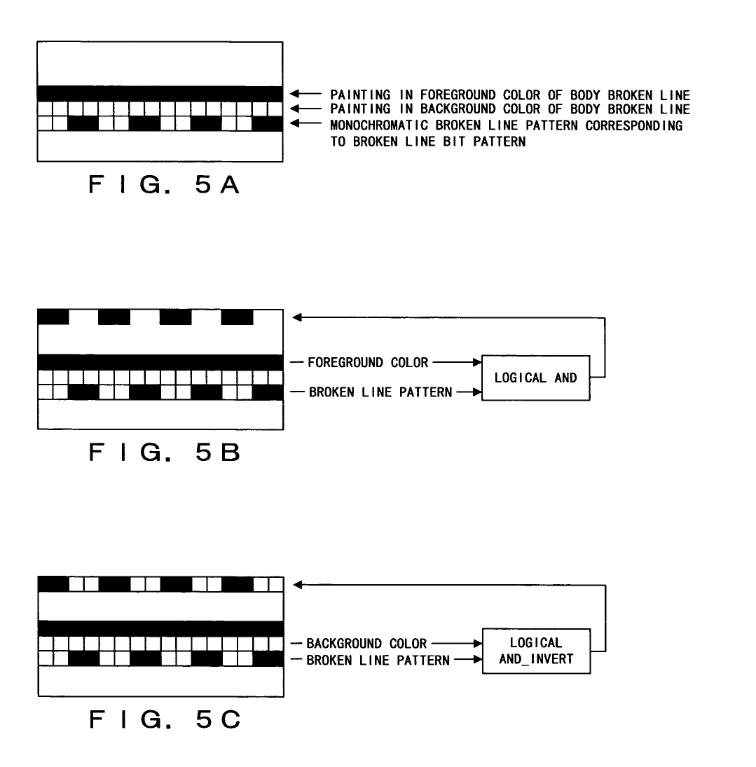

FIGS. 5A, 5B, and 5C are explanatory views of the process of generating a body broken line pattern in the broken line texture image.

In this process, the graphics LSI 3 first generates ablank broken line texture image in which an area (first area) where a broken line pattern by modifier function is arranged and an area (second area) as a broken line pattern generation work area are reserved in a specific area in the texture storage area 4b of the graphics memory 4.

Next, as shown in FIG. 5A, the first row in the broken line pattern generation work area of the generated broken line texture image is painted in the foreground color of the body broken line, and the second row is painted in the background color of the body broken line. Furthermore, the bit pattern for definition of a broken line pattern is replaced with a data string of the same bit width as the color information, and the result is copied to the third row in the broken line pattern generation work area. At this time, in the third row, the pattern in which a partial area having the color information about “1” for all bits and a partial area having the color information about “0” for all bits alternately appear is generated depending on the broken line pattern. If the pattern is expressed by color, a monochromatic pattern is generated. In this example, the pattern corresponding to the foreground color of the body broken line is replaced with white, and the pattern corresponding to the background color of the body broken line is replaced with black. The bit pattern for definition of a broken line pattern is specified by the graphics LSI 3 or the CPU 1.

Next, as shown in FIG. 5B, a logical product arithmetic is performed for each bit between the monochromatic broken line pattern in the third row in the broken line pattern generation work area and the pattern painted in the foreground color of the body broken line in the first row of the broken line pattern generation work area. The result of the arithmetic operation is written to the body broken line pattern storage row as the first row (first rowof the first area) of the broken line texture image. However, at this time, the bit of zero as a result of the logical operation, that is, the bit of the result of the logical operation with the pattern of the black portion in the monochromatic broken line pattern is not written.

Then, as shown in FIG. 5C, a logical product inverse arithmetic is performed for each bit between the monochromatic broken line pattern in the third row in the broken line pattern generation work area and the pattern painted in the background color of the body broken line in the second row of the broken line pattern generation work area. The result of the arithmetic operation is written to the body broken line pattern storage row as the first row of the broken line texture image. However, at this time, the bit of zero as a result of the logical operation, that is, the bit of the result of the logical operation with the pattern of the white portion in the monochromatic broken line pattern is not written.

In the above-mentioned process, a broken line texture image is generated in the texture storage area 4b, and a body broken line pattern is generated in the first row.

Next, the process of generating a frame broken line pattern in the second row (second row of the first area) of the broken line texture image is similarly performed.

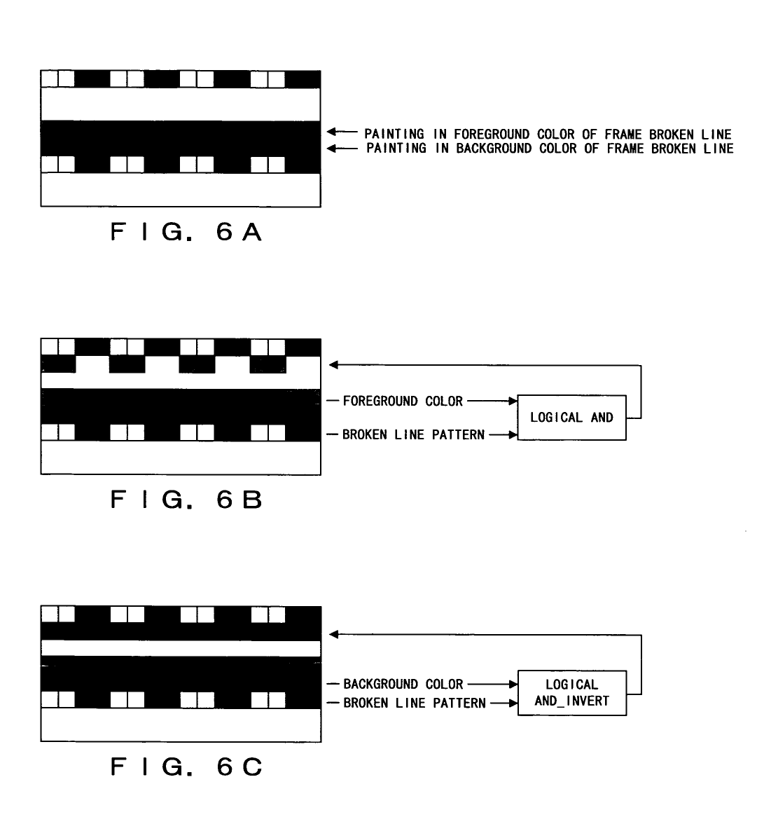

FIGS. 6A, 6B, and 6C are explanatory views of the process of generating a frame broken line pattern.

As shown in FIG. 6A, the first row in the broken line pattern generation work area of a broken line texture image is painted in the foreground color of the frame broken line, and the second row is painted in the background color of the frame broken line. These lines are painted in the foreground and background colors of the body broken line as shown in FIG. 5C, but they are overwritten. Since there is no change in bit pattern for definition of a broken line pattern, the third row of the broken line pattern generation work area is not processed.

As shown in FIG. 6B, a logical product arithmetic is performed for each bit between the monochromatic broken line pattern in the third row in the broken line pattern generation work area and the pattern painted in the foreground color of the frame broken line in the first row of the broken line pattern generation work area. The result of the arithmetic operation is written to the frame broken line pattern storage row as the second row of the broken line texture image. However, at this time, the bit of zero as a result of the logical operation, that is, the bit of the result of the logical operation with the pattern of the black portion in the monochromatic broken line pattern is not written.

Then, as shown in FIG. 6C, a logical product inverse arithmetic is performed for each bit between the monochromatic broken line pattern in the third row in the broken line pattern generation work area and the pattern painted in the background color of the frame broken line in the second row of the broken line pattern generation work area. The result of the arithmetic operation is written to the frame broken line pattern storage row as the second row of the broken line texture image. However, at this time, the bit of zero as a result of the logical operation, that is, the bit of the result of the logical operation with the pattern of the white portion in the monochromatic broken line pattern is not written.

In the above-mentioned process, a frame broken line pattern is generated in the second row of the broken line texture image.

Next, the process of generating a shading broken line pattern in the third row (third row of the first area) of the broken line texture image is similarly performed.

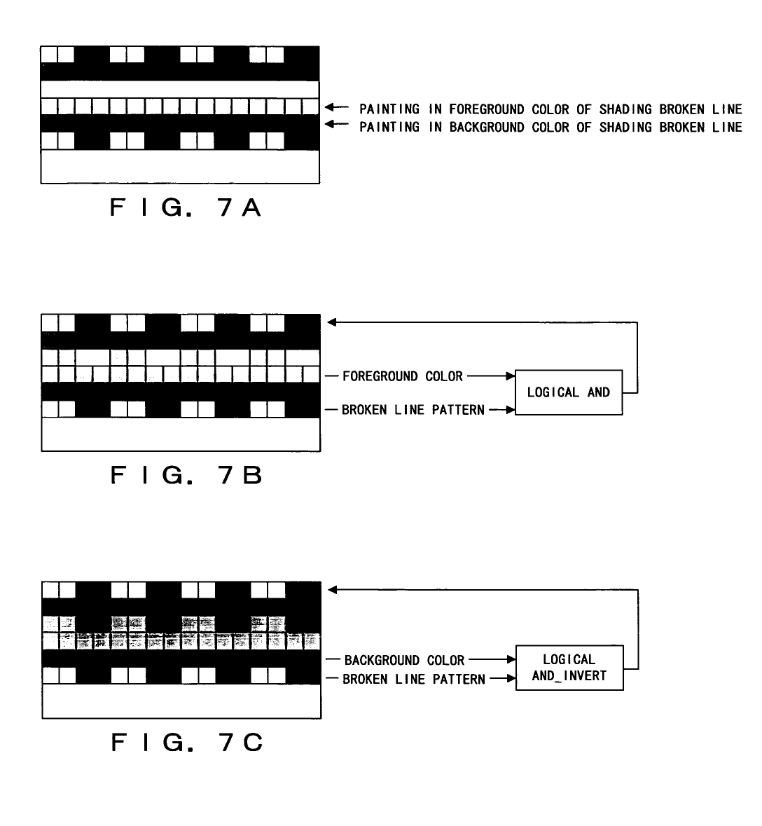

FIGS. 7A, 7B, and 7C are explanatory views of the process of generating a shading broken line pattern.

As shown in FIG. 7A, the first row in the broken line pattern generation work area of a broken line texture image is painted in the foreground color of the shading broken line, and the second row is painted in the background color of the shading broken line. These lines are painted in the foreground and background colors of the frame broken line as shown in FIG. 6C, but they are overwritten. Since there is no change in bit pattern for definition of a broken line pattern, the third row of the broken line pattern generation work area is not processed.

As shown in FIG. 7B, a logical product arithmetic is performed for each bit between the monochromatic broken line pattern in the third row in the broken line pattern generation work area and the pattern painted in the foreground color of the shading broken line in the first row of the broken line pattern generation work area. The result of the arithmetic operation is written to the shading broken line pattern storage row as the third row of the broken line texture image. However, at this time, the bit of zero as a result of the logical operation, that is, the bit of the result of the logical operation with the pattern of the black portion in the monochromatic broken line pattern is not written.

Then, as shown in FIG. 7C, a logical product inverse arithmetic is performed for each bit between the monochromatic broken line pattern in the third row in the broken line pattern generation work area and the pattern painted in the background color of the shading broken line in the second row of the broken line pattern generation work area. The result of the arithmetic operation is written to the shading broken line pattern storage row as the third row of the broken line texture image. However, at this time, the bit of zero as a result of the logical operation, that is, the bit of the result of the logical operation with the pattern of the white portion in the monochromatic broken line pattern is not written.

In the above-mentioned process, a shading broken line pattern is generated in the third row of the broken line texture image.

In the above-mentioned generating process, a broken line texture image including the body, frame, and shading broken line patterns shown in FIG. 2 is generated in the texture storage area 4b.

Thus, in the generating process, a broken line texture image can be more simply and easily generated.

The pattern of a generated broken line texture image is left in the broken line pattern generation work area as shown in FIG. 7C. However, it does not have an influence on the subsequent processes, it does not matter at all. It is also possible to store a generated broken line texture image in the storage device not shown in the attached drawings, and load it into the texture storage area 4b next time it is used. Another broken line pattern by modifier function can be additionally generated for the generated broken line texture image.

As described above, according to the graphic system of the mode for embodying the present invention, when a broken line pattern is pasted to the same segment to draw a broken line, a broken line by modifier function can be drawn only by moving the coordinates in the same broken line texture image without switching the reference texture image. Therefore, since a broken line by modifier function can be drawn without switching a drawing attribute, the performance degradation by overheads can be reduced.

In addition, since a texture image is not generated for each broken line by modifier function, but one texture image is generated using a set of broken lines by modifier function to be applied to the same segment, a texture image can be easily managed.

Furthermore, since a broken line texture image is generated as explained above by referring to FIGS. 5A, 5B, 5C, 6A, 6B, 6C, 7A, 7B, and 7C, a broken line texture image can be more simply and easily generated.

In the above-mentioned mode for embodying the present invention, an example of three broken line patterns for a body, frame, and shading as broken line patterns by modifier function included in a broken line texture image. However, for example, two of them can be used, or two or more broken line patterns from among the patterns obtained by adding other one or more broken line patterns to the three broken line patterns can be used.

Furthermore, in the above-mentioned mode for embodying the present invention, the arrangement row of the broken line patternbymodifier functionarrangedinthebroken line texture image can be predetermined for each modifier function.

As described above, the present invention has been explained in detail, but the present invention is not limited to the above-mentioned mode for embodying the present invention. That is, within the scope of the gist of the present invention, various improvements and changes can be made.

According to the present invention, a broken line texture image can be easily generated and managed, and the performance degradation by the overhead required when a broken line texture image is pasted can be reduced.

What is claimed is:

1. A graphic system, comprising:
a storage unit storing a broken line texture image in which a broken line pattern by modifier function is arranged;
a read unit reading a specific broken line pattern arranged in the broken line texture image based on coordinates on the broken line texture image; and
a drawing unit drawing a broken line using a broken line pattern read by the read unit.

2. The system according to claim 1, wherein
the broken line pattern by modifier function is arranged for each row in the broken line texture image.

3. The system according to claim 2, wherein
the read unit reads a specific broken line pattern based on coordinates indicating a vertical direction of the broken line texture image.

4. The system according to claim 1, wherein
in the broken line texture image, two or more of a body broken line pattern, a frame broken line pattern, and a shading broken line pattern are arranged as the broken line patterns by modifier function.

5. The system according to claim 1, wherein
the storage unit stores a broken line texture image for each set of broken line patterns by modifier function applied to the same segment.

6. The system according to claim 1, further comprising:
a generation unit newly generating a broken line texture image having a first area in which a broken line pattern by modifier function is arranged and a second area used as a work area in which the broken line pattern is generated;
a paint unit painting a first row in the second area in a foreground color of a broken line, and painting a second row in the second area in a background color of the broken line;
an assigned color paint unit painting in assigned color a third row in the second area corresponding to a pattern of the broken line; and
a write unit writing a broken line pattern relating to the broken line to a specific row in the first area based on the first and second rows painted by the paint unit and the third row painted in assigned color by the assigned color paint unit.

7. The system according to claim 6, wherein
the assigned color paint unit paints in assigned color the third row in the second area as a portion having color information about 1 for all bits and a portion having color information about 0 for all bits corresponding to the pattern of the broken line.

8. The system according to claim 6, wherein
the write unit writes a broken line pattern relating to the broken line in a specific row in the first area based on a logical operation result between the first row painted by the paint unit and the third row painted in assigned color by the assigned color paint unit, and a logical operation result between the second row painted by the paint unit and the third row painted in assigned color by the assigned color paint unit.

9. A broken line texture image generation apparatus, comprising:
a generation unit newly generating a broken line texture image having a first area in which a broken line pattern by modifier function is arranged and a second area used as a work area in which the broken line pattern is generated;
a paint unit painting a first row in the second area in a foreground color of a broken line, and painting a second row in the second area in a background color of the broken line;
an assigned color paint unit painting in assigned color a third row in the second area corresponding to a pattern of the broken line; and
a write unit writing a broken line pattern relating to the broken line to a specific row in the first area based on the first and second rows painted by the paint unit and the third row painted in assigned color by the assigned color paint unit.

10. The apparatus according to claim 9, wherein
the assigned color paint unit paints in assigned color the third row in the second area as a portion having color information about 1 for all bits and a portion having color information about 0 for all bits corresponding to the pattern of the broken line.

11. The apparatus according to claim 9, wherein
the write unit writes a broken line pattern relating to the broken line in a specific row in the first area based on a logical operation result between the first row painted by the paint unit and the third row painted in assigned color by the assigned color paint unit, and a logical operation result between the second row painted by the paint unit and the third row painted in assigned color by the assigned color paint unit.

12. A broken line texture image generating method, comprising:
generating a broken line texture image having a first area in which a broken line pattern by modifier function is arranged and a second area used as a work area in which the broken line pattern is generated;
painting a first row in the second area in a foreground color of a broken line;
painting a second row in the second area in a background color of the broken line;
painting in assigned color a third row in the second area corresponding to a pattern of the broken line; and
writing a broken line pattern relating to the broken line to a specific row in the first area based on the painted first and second rows and the third row painted in assigned color.

13. The method according to claim 12, wherein
the third row in the second area is painted in assigned color as a portion having color information about 1 for all bits and a portion having color information about 0 for all bits corresponding to the pattern of the broken line.

14. The method according to claim 12, wherein
a broken line pattern relating to the broken line is written in a specific row in the first area based on a logical operation result between the first painted row and the third row painted in assigned color, and a logical operation result between the second painted row and the third row painted in assigned color.
